(19) United States
(12) Patent Application Publication
(10) Pub. No.: US 2006/0120946 A1
(43) Pub. Date: Jun. 8, 2006

(54) Chemical process and apparatus

(75) Inventors: Nina Simic, Torslanda (SE); Kalle Pelin, Ytterby (SE)

Correspondence Address: WHITE, REDWAY & BROWN LLP, 1217 KING STREET, ALEXANDRIA, VA, 22314, US

(73) Assignee: Akzo Nobel N.V., SB Arnhem (NL)

(21) Appl. No.: 11/281,929

(22) Filed: Nov. 18, 2005

Related U.S. Application Data
(60) Provisional application No. 60/633,129, filed on Dec. 6, 2004.

(51) Int. Cl. C01B 11/02

(52) U.S. Cl. 423/478

(57) ABSTRACT

The invention relates to a process for the production of chlorine dioxide in an apparatus comprising a reaction vessel holding a reaction medium and a circulation conduit leading through a heater for the reaction medium, said process comprising the steps of continuously: a) maintaining the reaction medium at subatmospheric pressure and a temperature sufficient for evaporating water; b) circulating reaction medium through the circulation conduit and the heater; c) reacting alkali metal chlorate, sulfuric acid and hydrogen peroxide in the reaction medium to form chlorine dioxide, oxygen and alkali metal sulfate; d) feeding alkali metal chlorate, sulfuric acid and hydrogen peroxide to the reaction medium, wherein the sulfuric acid is fed through an inlet into the circulation conduit and the hydrogen peroxide is fed through an inlet directly into the reaction vessel or through an inlet into the circulation conduit down-streams the inlet for sulfuric acid at a distance in the flow direction therefrom of at least about the inner diameter of the circulation conduit; and, e) withdrawing a gas comprising chlorine dioxide, oxygen and evaporated water. The invention further relates to an apparatus for the production of chlorine dioxide.

The present invention relates to a process and an apparatus for the production of chlorine dioxide from alkali metal chlorate, sulfuric acid and hydrogen peroxide.

Chlorine dioxide used in aqueous solution is of considerable commercial interest, mainly in pulp bleaching, but also in water purification, fat bleaching, removal of phenols from industrial wastes etc. It is therefore desirable to provide processes in which chlorine dioxide can be efficiently produced.

There are numerous different processes for chlorine dioxide production. Most large scale processes in commercial use involve continuous reaction of alkali metal chlorate in an acidic reaction medium with a reducing agent such as hydrogen peroxide, methanol, chloride ions or sulfur dioxide to form chlorine dioxide that is withdrawn as a gas from the reaction medium. Generally, the acidity is mainly provided by addition of sulfuric acid and the sulfate is withdrawn as a by-product in the form of solid alkali metal sulfate or dissolved in depleted reaction medium.

In one kind of processes the reaction medium is maintained in a single reaction vessel under boiling conditions at subatmospheric pressure, wherein alkali metal salt of the acid is precipitated and withdrawn as a salt cake. A particularly efficient reducing agent is hydrogen peroxide, as described in e.g. G. Charles et al, Pima's Papermaker, January 1998, p. 74-75, “Generate more chlorine dioxide, less BOD using hydrogen peroxide” and U.S. Pat. Nos. 5,091,166 and 5,091,167. However, it has been found difficult to maintain stochiometric consumption of hydrogen peroxide during long term operation in full scale.

U.S. Pat. No. 5,366,714 deals with that problem and discloses a process in which the hydrogen peroxide is fed pre-mixed with alkali metal chlorate and sulfuric acid.

U.S. Pat. No. 4,421,730 discloses a process in which alkali metal chlorate is reduced by chloride ion in the presence of hydrogen peroxide and a complex catalyst of palladium (II) with chloride ion.

It has now been found that hydrogen peroxide and sulfuric acid in the reaction medium may react to form Caro's acid, H₂SO₅. Caro's acid is a very strong oxidant and the conditions in a production process for chlorine dioxide may favour unwanted side reactions leading to a loss of hydrogen peroxide, such as reaction of Caro's acid with hydrogen peroxide to form sulfuric acid and oxygen or with chloride to form chlorine.

Even if the reaction medium in a chlorine dioxide plant normally is well mixed, there are always concentration gradients around the feed inlets with zones where the local concentrations of the respective feed chemicals are higher than in the reaction medium as a whole. According to the present invention, hydrogen peroxide and sulfuric acid should be fed in a way to minimise the risk that the zones with high concentrations thereof coincide.

An aspect of the present invention thus concerns a process for the production of chlorine dioxide in an apparatus comprising a reaction vessel holding a reaction medium and a circulation conduit leading through a heater for the reaction medium, said process comprising the steps of continuously:
a) maintaining the reaction medium at subatmospheric pressure and a temperature sufficient for evaporating water;
b) circulating reaction medium through the circulation conduit and the heater;
c) reacting alkali metal chlorate, sulfuric acid and hydrogen peroxide in the reaction medium to form chlorine dioxide, oxygen and alkali metal sulfate;
d) feeding alkali metal chlorate, sulfuric acid and hydrogen peroxide to the reaction medium, wherein the sulfuric acid is fed through an inlet into the circulation conduit and the hydrogen peroxide is fed through an inlet directly into the reaction vessel or through an inlet into the circulation conduit down-streams the inlet for sulfuric acid at a distance in the flow direction therefrom of at least about the inner diameter of the circulation conduit; and,
e) withdrawing a gas comprising chlorine dioxide, oxygen and evaporated water.

The pressure and the temperature are set so to evaporate water to dilute the chlorine dioxide formed and withdrawn from the reaction medium. Preferably the reaction medium is maintained at a temperature about 15 to about 100° C., most preferably from about 30 to about 85° C. Suitably the reaction medium is maintained at an absolute pressure from about 8 to about 80 kPa, preferably from about 8 to about 55 kPa, most preferably from about 10 to about 50 kPa. Preferably the reaction medium is maintained at its boiling point at the prevailing pressure.

As the evaporation of water from the reaction medium consumes more energy than generated in the process, this is balanced by supplying heat to the reaction medium circulating through the heater in the circulation conduit. Any kind of heater may be used, such as heat exchangers heated by steam or any other hot fluid medium.

The concentration of alkali metal chlorate maintained in the reaction medium may vary within wide limits, for example from about 0.25 moles/litre up to saturation, preferably from about 1.5 moles/litre up to saturation, most preferably from about 2.5 moles/litre up to saturation.

The acidity of the reaction medium is preferably maintained from about 0.5 to about 12 N, more preferably from about 1 to about 10 N, most preferably from about 1.5 to about 7 N.

In one embodiment the hydrogen peroxide is fed through an inlet directly into the reaction vessel. Preferably, the reaction vessel comprises a substantially conical portion and on top thereof, a substantially cylindrical portion. In such a case, the hydrogen peroxide is preferably fed through an inlet into the substantially cylindrical portion of the reaction vessel.

In another embodiment the hydrogen peroxide is fed through an inlet into the circulation conduit down-streams the inlet for sulfuric acid at a distance in the flow direction therefrom of at least about the inner diameter of the circulation conduit, preferably at least about twice, more preferably at least about five times, most preferably at least about ten times the inner diameter of the circulation conduit. An advantage of this embodiment is that more of the chlorine dioxide formation occurs in the circulation conduit, which facilitates the withdrawal thereof in the reaction vessel.

The inner diameter of the conduit depends on the capacity of the production plant and is preferably designed to ensure that the flow therein is turbulent. A suitable inner diameter may, for example, be from about 10 to about 100 cm, preferably from about 20 to about 60 cm. In the case the cross-section of the circulation conduit is not circular the diameter required for the same cross-section area in a conduit with circular cross-section is referred to.

By keeping the feed inlets for sulfuric acid and hydrogen peroxide at a long distance from each other the risk for formation of Caro's acid is decreased. However, the optimal positions of the feed inlets from a chemical point of view cannot always be achieved for practical reasons, particularly if an already existing plant is modified, but also a compromise with a reasonably low formation of Caro's acid is within the scope of the invention.

Preferably the amount of hydrogen peroxide fed is from about 0.5 to about 2 moles per mole alkali metal chlorate fed, most preferably from about 0.5 to about 1 mole per mole alkali metal chlorate fed, particularly most preferably from about 0.5 to about 0.6 moles per mole alkali metal chlorate fed.

The alkali metal chlorate, normally as a aqueous solution, may be fed anywhere directly into the reaction vessel or into the circulation conduit, for example up-streams or down-streams the heater or up-streams or down-streams the sulfuric acid inlet. It is also possible to feed the alkali metal chlorate as a pre-mixed solution with the hydrogen peroxide.

Any alkali metal chlorate may be used, such as chlorate of sodium, potassium or mixtures thereof. Normally sodium is preferred. It is also possible to feed a mixture of alkali metal chlorate and chloric acid, in which case the amount of sulfuric acid fed may be reduced.

The sulfuric acid may be fed anywhere into the circulation conduit, although it is preferred to feed it through an inlet down-streams the heater. The sulfuric acid fed preferably has a concentration from about 30 to about 98 wt %, most preferably from about 40 to about 70 wt %. Sulfuric acid of low concentration is easier to mix with the reaction medium, but a high concentration gives the advantage of utilisation of the heat of dilution.

It is preferred to operate the process under conditions to obtain precipitation of solid alkali metal sulfate in the reaction medium. Depending on the acidity of the reaction medium, substantially neutral sulfate or acidic sesquisulfate may form. However, it is also possible to operate the process under such conditions that no formation of solid alkali metal sulfate occurs.

At least some of the alkali metal sulfate formed is normally withdrawn, preferably as a solid salt cake which may be removed on a conventional filter, and may in some cases be used as a by-product. However, it is also possible to electrochemically acidify some of the alkali metal sulfate and recycle it to the reaction medium to replace some of the sulfuric acid feed. Such electrochemical acidification is described in e.g. U.S. Pat. Nos. 4,129,484, 5,478,446, 5,487,881, 5,858,322 and 6,322,690.

Chlorine dioxide is withdrawn as a gas together with oxygen and evaporated water and may be absorbed into water in a conventional way. In most cases, the chlorine dioxide is finally used as an aqueous solution, for example in a pulp bleach tower.

Although not necessary, it is possible to feed small amounts of chloride ions, preferably in the form of alkali metal chloride, so as to maintain the concentration thereof in the reaction medium within the range from about 0.001 up to about 0.8 moles/litre. However, it is preferred not to feed any chloride in addition to the chloride always being present as an impurity of the alkali metal chlorate. Preferably the total amount of chloride ions fed, including impurities in the chlorate, is below about 1 mole %, more preferably below about 0.1 mole %, even more preferably below about 0.05 mole %, most preferably below about 0.02 mole % Cl⁻ of the ClO₃⁻.

A further aspect of the invention concerns an apparatus for the production of chlorine dioxide comprising a reaction vessel, a circulation conduit leading through a heater, feed inlets for alkali metal chlorate, sulfuric acid and hydrogen peroxide, wherein the feed inlet for sulfuric acid leads into the circulation conduit, preferably down-streams the heater, and the feed inlet for hydrogen peroxide leads directly into the reaction vessel or into the circulation conduit down-streams the feed inlet for sulfuric acid at a distance in the flow direction therefrom of at least about the inner diameter of the circulation conduit.

For suitable and preferred embodiments of the apparatus the above description of the process is referred to.

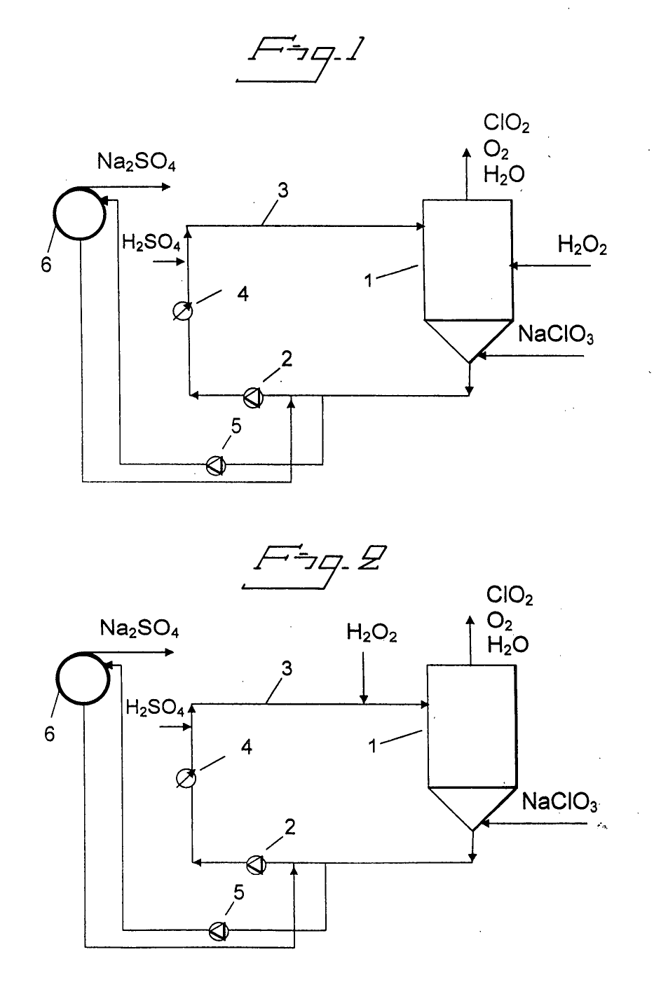

The invention will be further exemplified in connection with the accompanied drawings, of which the FIGS. 1 and 2 schematically show different embodiments thereof.

Referring to FIG. 1, an SVP® process for the production of chlorine dioxide according to the invention is schematically shown. A reaction vessel 1 holds an reaction medium under subatmospheric pressure. The reaction medium is circulated by a pump 2 through a circulation conduit 3 and a heater 4 (commonly called “reboiler”) and back to the reaction vessel 1 at a rate sufficient for keeping the temperature of the reaction medium at the boiling point. Hydrogen peroxide is fed into a substantially cylindrical portion of the reaction vessel 1, sodium chlorate into a substantial conical portion of the reaction vessel 1 and sulfuric acid into the circulation conduit 3 down-streams the heater 4. In the reaction medium sodium chlorate, hydrogen peroxide and sulfuric acid react to form chlorine dioxide, oxygen and sodium sulfate. Chlorine dioxide and oxygen are withdrawn as a gas together with evaporated water. Sodium sulfate precipitates as a substantially neutral or acidic salt, depending on the acidity of the reaction medium. By a pump 5 reaction medium is circulated through a filter 6 to separate and withdraw the solid sodium sulfate.

FIG. 2 shows a similar process with the only exception that the hydrogen peroxide is fed into the circulation conduit down-streams the feed point for sulfuric acid. The distance in the flow direction between the two feed points should be as long as practically possible and a least about the inner diameter of the conduit 3.

1. Process for the production of chlorine dioxide in an apparatus comprising a reaction vessel holding a reaction medium and a circulation conduit leading through a heater for the reaction medium, said process comprising the steps of continuously:
(a) maintaining the reaction medium at subatmospheric pressure and a temperature sufficient for evaporating water;
(b) circulating reaction medium through the circulation conduit and the heater;
(c) reacting alkali metal chlorate, sulfuric acid and hydrogen peroxide in the reaction medium to form chlorine dioxide, oxygen and alkali metal sulfate;
(d) feeding alkali metal chlorate, sulfuric acid and hydrogen peroxide to the reaction medium, wherein the sulfuric acid is fed through an inlet into the circulation conduit and the hydrogen peroxide is fed through an inlet directly into the reaction vessel or through an inlet into the circulation conduit down-streams the inlet for sulfuric acid at a distance in the flow direction therefrom of at least about the inner diameter of the circulation conduit; and,
(e) withdrawing a gas comprising chlorine dioxide, oxygen and evaporated water.

2. Process as claimed in claim 1, wherein the sulfuric acid is fed through an inlet into the circulation conduit down-streams the heater.

3. Process as claimed in claim 1, wherein the hydrogen peroxide is fed through an inlet directly into the reaction vessel.

4. Process as claimed in claim 3, wherein the reaction vessel comprises a substantially cylindrical portion on top of a substantially conical portion, and the hydrogen peroxide is fed into the substantially cylindrical portion.

5. Process as claimed in claim 1, wherein the hydrogen peroxide is fed through an inlet into the circulation conduit down-streams the inlet for sulfuric acid at a distance in the flow direction therefrom of at least about the inner diameter of the circulation conduit.

6. Process as claimed in claim 5, wherein the hydrogen peroxide is fed through an inlet into the circulation conduit down-streams the inlet for sulfuric acid at a distance in the flow direction therefrom of at least about five times the inner diameter of the circulation conduit.

7. Process as claimed in claim 6, wherein the inner diameter of the circulation conduit is from about 10 to about 100 cm.

8. Process as claimed in claim 1, wherein at least some of the alkali metal sulfate formed is withdrawn as a solid salt cake.

9. Apparatus for the production of chlorine dioxide comprising a reaction vessel, a circulation conduit leading through a heater, feed inlets for alkali metal chlorate, sulfuric acid and hydrogen peroxide, wherein the feed inlet for sulfuric acid leads into the circulation conduit and the feed inlet for hydrogen peroxide leads directly into the reaction vessel or into the circulation conduit down-streams the feed inlet for sulfuric acid at a distance in the flow direction therefrom of at least about the inner diameter of the circulation conduit.

10. Apparatus as claimed in claim 9, wherein the feed inlet for hydrogen peroxide leads directly into the reaction vessel.

11. Apparatus as claimed in claim 10, wherein the reaction vessel comprises a substantially cylindrical portion on top of a substantially conical portion, and the feed inlet for hydrogen peroxide leads into said substantially cylindrical portion of the reaction vessel.

12. Apparatus as claimed in claim 9, wherein the feed inlet for hydrogen peroxide leads into the circulation conduit down-streams the feed inlet for sulfuric acid at a distance in the flow direction therefrom of at least about the inner diameter of the circulation conduit.

13. Apparatus as claimed in claim 11, wherein the feed inlet for hydrogen peroxide leads into the circulation conduit down-streams the feed inlet for sulfuric acid at a distance in the flow direction therefrom of at least about five times the inner diameter of the circulation conduit.
